(19) United States
(12) Patent Application Publication
(10) Pub. No.: US 2014/0324602 A1
(43) Pub. Date: Oct. 30, 2014

(54) MANAGING DISTRIBUTION PARAMETER UTILIZATION

(71) Applicant: Google Inc., Mountain View, CA (US)

(72) Inventors: Patrick Hummel, Mountain View, CA (US); Uri Nadav, Mountain View, CA (US)

(73) Assignee: Google Inc., Mountain View, CA (US)

(21) Appl. No.: 14/082,966

(22) Filed: Nov. 18, 2013

(30) Foreign Application Priority Data
Apr. 28, 2013 (IL) 225992

(51) Int. Cl. G06Q 30/02

(52) U.S. Cl. CPC G06Q 30/0275
USPC 705/14.71

(57) ABSTRACT

Methods, systems, and apparatus, including computer programs encoded on a computer storage medium, for managing utilization of distribution parameters are disclosed. In one aspect, a method includes a restrictive distribution parameter that is different from any distribution parameters in a first set of distribution parameters. An acceptable peak bid for a second set of distribution parameters that includes the restrictive distribution parameter is determined based on a first bid for the first set of distribution parameters. A determination is made that a second bid received from the content item provider does not exceed the acceptable peak bid, and the second bid is associated with the second set of distribution parameters based on the determination.

### CROSS-REFERENCE TO RELATED APPLICATION

This application claims priority under 35 U.S.C. §119 to Israel Patent Application No. 225992, titled “MANAGING DISTRIBUTION PARAMETER UTILIZATION” filed Apr. 28, 2013, the disclosure of which is incorporated herein by reference in its entirety.

### BACKGROUND

This specification relates to data processing and content distribution.

The Internet facilitates the exchange of information and transactions between users across the globe. This exchange of information enables content item providers to provide sponsored content to a variety of users. A content item provider can control the distribution of their content items (e.g., promotions, advertisements, audio files, video files, or other content items) based on a set of distribution parameters that specify under what conditions a content item is eligible to be distributed. When a presentation opportunity meeting the conditions is available, the content item provided by a content item provider is deemed eligible to be provided for presentation.

### SUMMARY

In general, one innovative aspect of the subject matter described in this specification can be embodied in methods that include the actions of identifying, for a content item provider, a first set of distribution parameters for distributing a set of content items; receiving, from the content item provider, a restrictive distribution parameter that is included in a second different set of distribution parameters, wherein the restrictive distribution parameter is different from any distribution parameters in the first set of distribution parameters; identifying a first bid for the first set of distribution parameters, the first bid being based on a value that the content item provider has specified for distribution of a content item in response to a content item request that meets the first set of distribution parameters, but does not meet the second set of distribution parameters; determining an acceptable peak bid for the second set of distribution parameters, the acceptable peak bid being greater than and determined based at least in part on the first bid; receiving, from the content item provider, a second bid for the second set of distribution parameters, the second bid being a value that the content item provider has specified for distribution of a content item in response to a content item request that meets the second set of distribution parameters; determining that the second bid does not exceed the peak bid; and associating the second bid with the second set of distribution parameters. Other embodiments of this aspect include corresponding systems, apparatus, and computer programs, configured to perform the actions of the methods, encoded on computer storage devices. These and other embodiments can each optionally include one or more of the following features.

Methods can include operations including receiving, from the content item provider, a third bid that differs from the second bid; determining that the third bid exceeds the peak bid; providing information to the content item provider indicating that the third bid exceeds the peak bid.

Methods can include operations including receiving a first content item request including request data that meet the first set of distribution parameters, but do not meet the second set of distribution parameters; and providing, in response to receiving the first content item request, a bid associated with the first set of distribution parameters for use in a content item auction.

Methods can include operations including receiving a second content item request including request data that meets the second set of distribution parameters; and providing, in response to the second content item request the second bid for use in a content item auction.

Determining the peak bid can include identifying a bid adjustment value for the second set of distribution parameters; and computing the peak bid based on the bid adjustment value and the first bid.

Methods can include operations including determining a first number of content item auctions for which a bid for the first set of distribution parameters has been eligible; determining a second number of content item request auctions for which the second bid has been eligible; and determining, based on the first number of content item request auctions and the second number of content item request auctions, a use rate for the second set of distribution parameters.

Methods can include operations including determining that the use rate for the second set of distribution parameters meet a threshold use rate for the second set of distribution parameters; and disabling the second bid for at least one content item request.

Particular embodiments of the subject matter described in this specification can be implemented so as to realize none, one or more of the following advantages. Content item providers are incentivized to distribute content items in response to a variety of content item requests. For example, content item providers are incentivized to compete for content item broad content item requests (also referred to as less specific content item requests) and more specific content item requests. The broad content item requests generally meet fewer, or less specific, distribution criteria than the specific content item requests. A content item provider is incentivized to compete for the broad content item requests by granting the content item provider access to the specific content item requests based on the number of the broad content item requests for which the content item provider competes. The quality of content items provided in response to a broad content item request is maintained by encouraging, through the incentives, greater competition for the broad set of content item requests. Thus, the quality of content items presented to users is maintained, thereby maintaining a consistent user experience.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content is distributed to user devices.

FIG. 2 is a flow chart of an example process for managing utilization of a set of distribution parameters.

FIG. 3 is a flow chart of an example process for temporally managing utilization of distribution parameters.

FIG. 4 is block diagram of an example computer system.

Like reference numbers and designations in the various drawings indicate like elements.

### DETAILED DESCRIPTION

The types of content item requests for which content item providers are able to compete is managed to facilitate competition across various types of content item requests. The various types of content item requests can include, for example, specific content item requests (e.g., content item requests that meet a particular set of distribution criteria) and less specific content item requests (e.g., content item requests that meet a set of distribution criteria that is less restrictive than the particular set of distribution criteria). In some implementations, the number or portion of the specific content item requests for which a content item provider can compete is based, at least in part, on a number or portion of the less specific content item requests for which the content item provider competes. In some implementations, a peak bid that a content item provider can submit to compete for the specific content item requests is based, at least in part, on one or more bids that the content item provider has submitted for the less specific content item requests.

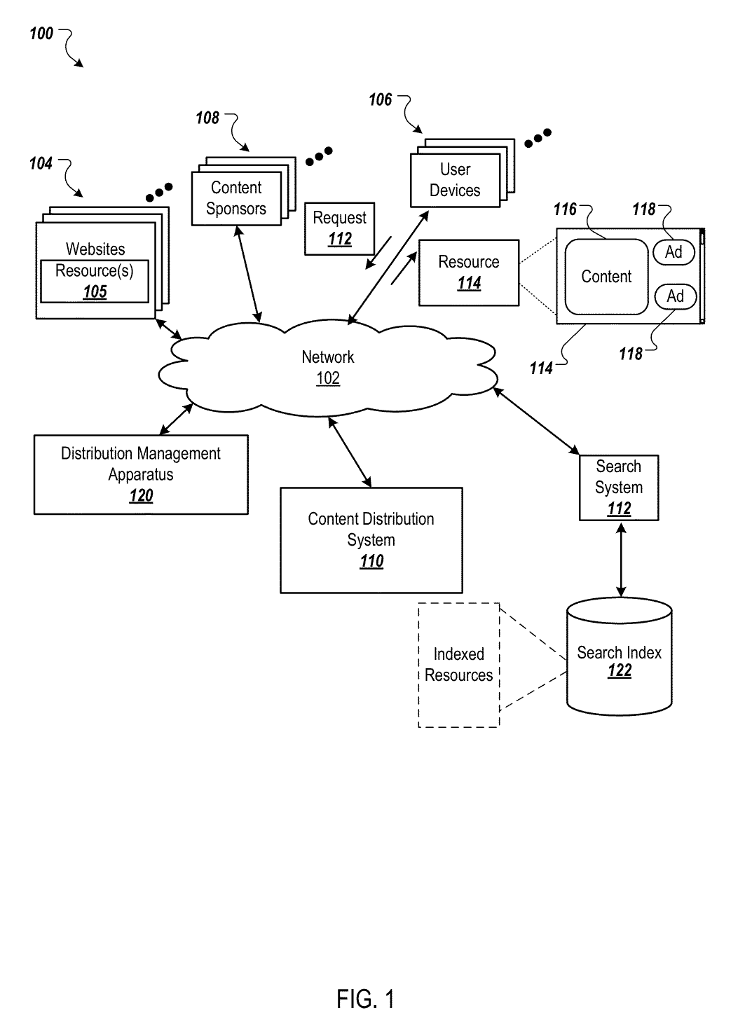

FIG. 1 is a block diagram of an example environment 100 in which content is distributed to user devices 106. The example environment 100 includes a network 102, such as a local area network (LAN), a wide area network (WAN), the Internet, or a combination thereof. The network 102 connects websites 104, user devices 106, content sponsors 108, and a content distribution system 110. The example environment 100 may include many different websites 104, user devices 106, and content sponsors 108.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as scripts). Units of content that are presented in (or with) resources are referred to as content items, and an individual content item can be stored in a single file or set of files independent of the resource.

A user device 106 is an electronic device that is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can submit a resource request 112 that requests a resource 105 from a website 104. In turn, data representing the requested resource 114 can be provided to the user device 106 for presentation by the user device 106. The requested resource 114 can be, for example, a home page of a website 104, web page from a social network, or another resource 105. The data representing the requested resource 114 can include data that cause presentation of resource content 116 at the user device 106. The data representing the requested resource 114 can also include data specifying content item slots 118. A content item slot is a portion of the resource (e.g., a portion of a web page) or a portion of a user display (e.g., a presentation location of another window or in a slot of a web page) in which content items, such as advertisements, can be presented. Content items slots 118 can also be referred to as advertisement slots, but any type of content (e.g., content items other than advertisements) can be presented in these content item slots 118.

To facilitate searching of these resources, the environment 100 can include a search system 112 that identifies the resources by crawling and indexing the resources provided by the publishers on the websites 104. Data about the resources can be indexed based on the resource with which the data are associated. The indexed and, optionally, cached copies of the resources are stored in a search index 122. Data that are associated with a resource is data that represents content included in the resource and/or metadata for the resource.

User devices 106 can submit search queries to the search system 112 over the network 102. In response, the search system 112 accesses the search index 122 to identify resources that are relevant to the search query. The search system 112 identifies the resources in the form of search results and returns the search results to the user device in search results page. A search result is data generated by the search system 112 that identifies a resource that is responsive to a particular search query, and includes a link to the resource. An example search result can include a web page title, a snippet of text or a portion of an image extracted from the web page, and the URL of the web page. Like other resources, search results pages can include one or more content item slots in which content items, such as advertisements, can be presented.

When a resource 105 is requested by a user device 106, execution of code associated with a slot in the resource initiates a request for a content item to populate the slot. When a resource 105 requests a content item, the presentation of the content item is referred to as an impression. As used throughout this document, the term impression refers to a presentation opportunity for a content item. Impressions are considered to be allocated to the content sponsors that are selected to provide a selected content item for presentation.

In some situations, impressions are allocated by a content distribution system 110. For example, some publishers enter into an agreement to have slots on their resources 105 populated by third party content items selected by the content distribution system 110. In these situations, the publisher will generally include, in the slots, code that when executed by the user device 106, submits a request (i.e., a content item request that requests an advertisement) to the content distribution system 110.

The request can include characteristics of the slots that are defined for the requested resource 114. For example, a reference (e.g., URL) to the requested resource 114 for which the slot is defined, a size of the slot, and/or media types that are eligible for presentation in the slot can be provided to the content distribution system 110. Similarly, keywords associated with a requested resource (“resource keywords”) or entities that are referenced by the resource can also be provided to the content distribution system 110 to facilitate identification of content items that are relevant to the requested resource 114. The requests can also include other information, such as information that the user has provided, geographic information indicating a state or region from which the request was submitted, or other information that provides context for the environment in which the content item will be displayed (e.g., a type of device at which the content item will be displayed, such as a mobile device or tablet device).

The content items that are provided in response to a request (or another content item request) are selected based on distribution parameters associated with the content items. Distribution parameters are a set of criteria upon which distribution of content items are conditioned. In some implementations, the distribution criteria for a particular content item can include distribution keywords that must be matched (e.g., by resource keywords or search queries) in order for the content item to be eligible for presentation. The distribution criteria can also specify a bid and/or budget for distributing the particular content item. Bids can be used to conduct an auction to select which content item(s) will be presented and/or in which slot the content item(s) will be presented. A content item provider can specify a budget, which will limit the maximum amount that the content item provider will spend over a specified period.

Some content item providers specify different bids for different sets of distribution parameters. For example, assume that a content item provider that distributes a content item related to a college basketball team from Michigan specifies a first set of distribution parameters that includes the distribution keyword “basketball.” Content items distributed based on this first set of distribution parameters will be eligible for presentation when the keyword “basketball” is matched by data included in a content item request, and the content item provider may be willing to pay a specified price for distribution of content items based on the first set of distribution parameters.

Continuing with this example, the content item provider may also specify a second set of distribution parameters that includes the distribution keyword “basketball” and also includes an additional distribution parameter, such as a geographic distribution parameter (e.g., Michigan). The geographic distribution parameter can require, for example, a content item request to include data referencing a particular geographic location, or one of multiple specified geographic locations, in order for a content item to be eligible to be provided in response to the request. To illustrate, the content item provider in the example above may only want a particular set of content items distributed in response to content item requests that reference Michigan, since the college basketball team is located in Michigan. Therefore, the content item provider may include the additional distribution parameter “Michigan” in the second set of distribution parameters. Because the second set of distribution parameters is more restrictive than the first set of distribution parameters, e.g., requiring the content item request to include data matching the keyword “basketball” and include a reference to Michigan, the content item provider may associate a higher bid with the second set of distribution parameters.

As content item providers continue to be enabled to specify more specific sets distribution parameters, and therefore, distribute their content items in response to more specific requests (e.g., requests that include data matching the more specific set of distribution parameters), content item providers may allocate a larger portion of their monetary resources to distribution of content items based on the more specific sets distribution parameters. This diversion of resources to the more specific sets of distribution parameters may result in fewer content item providers competing to provide content items in response to less specific requests that may not include all of the data required to meet these more specific sets of distribution parameters. However, these less specific requests may still be valuable requests, for example, because they may be obtained for a lower price than the more specific request, and may provide a similar return on investment as the more specific requests. The lack of competition for the less specific content item requests could reduce the quality of content items provided in response to the less specific requests, which could negatively affect the user experience, and also impact revenue generated by those less specific requests.

As described in more detail below, competition for the less specific requests can be encouraged by providing content item providers incentives with respect to the more specific content item requests. In some implementations, the incentives can be based on the content item provider's level of competition for the less specific content item requests. For example, the number of times, or rate at which, a content item provider competes for less specific requests can be used to determine a number of times, or rate at which, that content item provider can compete for more specific requests. Thus, a content item provider may be able to compete for an increased number of more specific requests by increasing the number of less specific requests for which the content item provider competes. Similarly, the peak bid (e.g., highest bid) that will be accepted from a content item provider for a more specific request can be based on one or more bids that the content item provider has submitted for less specific content item requests. Thus, a content item provider may be able to increase the bid that they are able to submit for more specific requests by increasing their bid for less specific requests.

The environment 100 includes a distribution management apparatus 120 that manages the utilization of sets of distribution parameters by content item providers. In some implementations, the distribution management apparatus 120 manages the utilization of a set of distribution parameters by determining a highest bid that will be accepted from the content item provider, which is referred to as an acceptable peak bid or a peak bid. The peak bid can be determined, for example, based at least in part, on one or more other bids received from the content item provider. In a particular example, the peak bid for the second set of distribution parameters in the example above can be based on one or more bids that the content item provider has specified for the first set of distribution parameters. In some implementations, the distribution management apparatus 120 determines the peak bid for the second set of distribution parameters based on a multiple of a bid associated with the first set of distribution parameters, a percentage of the bid associated with the first set of distribution parameters, or another value determined based on the bid associated with the first set of distribution parameters (e.g., an exponential of the bid associated with the less specific requests or an amount added to the bid associated with the less specific requests).

In some implementations, the distribution management apparatus 120 determines the peak bid based on a multiple of (or some specified amount greater than) a bid that is associated with a different set of distribution parameters. For example, assume that first content item provider in the example above has specified a bid of $10 for the first set of distribution parameters, and that the distribution management apparatus 120 will accept, for the second set of distribution parameters, a peak bid that is three times higher than the bid specified for the first set of distribution parameters. In this example, the peak bid that will be accepted from the first content item provider for the second set of distribution parameters is $30. Continuing with this example, if a second content item provider has specified a bid of $3 for the first set of distribution parameters, the peak bid that will be accepted from the second content item provider for the second set of distribution parameters will be $9. As described below, the bid upon which the peak bid is based can be based on a historical bid price, such as a lowest price that has been associated with the first set of distribution parameters or a current bid price that is associated with the first set of distribution parameters.

In some implementations, the distribution management apparatus 120 temporally manages utilization of a set of distribution parameters. The distribution management apparatus 120 temporally manages utilization by limiting how often a content item provider can utilize a set of distribution parameters. In some implementations, the distribution management apparatus 120 can manage how often a set of distribution parameters is utilized by a content item provider based on the extent to which (e.g., how often) another set of distribution parameters is used by the content item provider.

To illustrate, the distribution management apparatus 120 can manage the use of the second set of distribution parameters in the example above based on the rate of use of the first set of distribution parameters. For example, assume that in one hour the first content item provider competes for two hundred content item requests that meet the first set of distribution parameters. In this example, the number of content item requests meeting the second set of distribution parameters that the first content item provider can compete for in an hour period (e.g., the next hour period) can be some multiple of, or portion of, two hundred (i.e., the number of content item requests meeting the first set of distribution parameters for which the first content item provider competed).

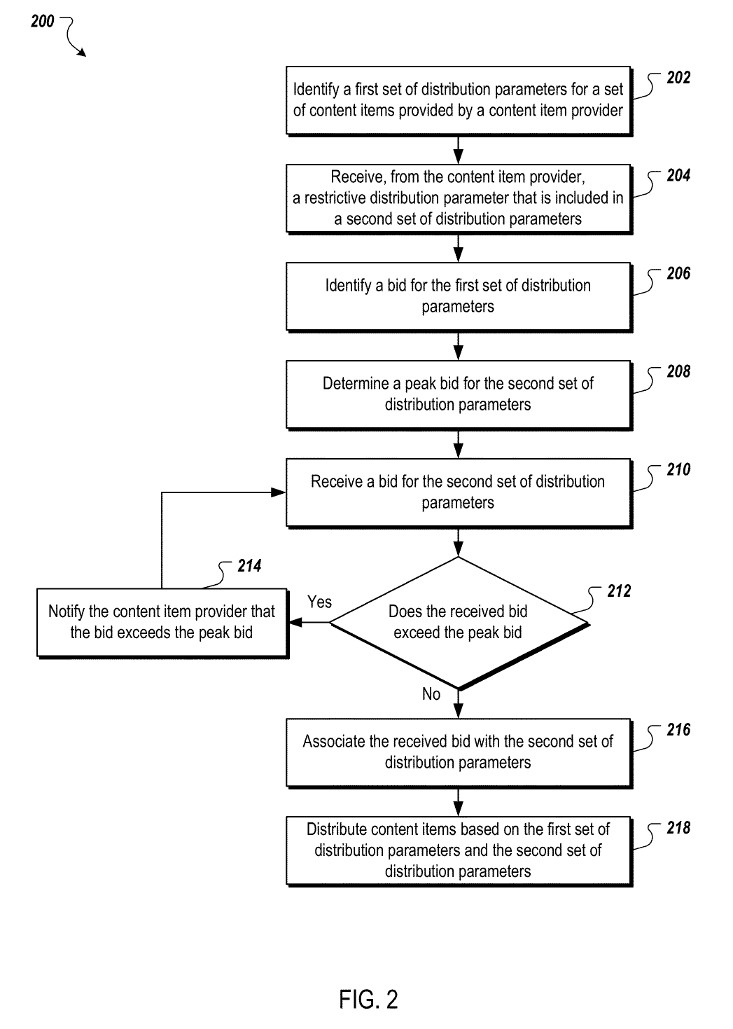

FIG. 2 is a flow chart of an example process 200 for managing utilization of a set of distribution parameters. The process 200 can be performed by one or more data processing apparatus, such as the distribution management apparatus 120 and/or the content distribution system 110 of FIG. 1. Operations of the process 200 can be implemented by execution of instructions stored on a non-transitory computer readable medium and that cause one or more data processing apparatus to perform operations of the process 200.

A first set of distribution parameters is identified (202). In some implementations, the first set of distribution parameters is associated with a content item provider and controls distribution of one or more content items provided by the content item provider. For example, the first set of distribution parameters can specify the data that must be included in a content item request for a particular content item to be eligible to be provided in response to the content item request.

To illustrate, assume that a content item provider, such as an advertiser, has specified that a content item, such as an advertisement, is eligible to be provided to user devices that, based on the information included in a content item request, have submitted a search query that matches the distribution keyword “basketball.” This distribution keyword alone, or in combination with other distribution parameters, constitutes a set of distribution parameters that controls distribution of the content item.

In this example, the first set of distribution parameters controls distribution of the content item by making the content item eligible for distribution in response to content item requests that include data specifying that the user device to which a selected content item will be distributed submitted a request (e.g., associated with a search query or slot) that matches (e.g., is the same as or has a specified level of similarity to) the distribution keyword “basketball.” When a content item request includes data matching the distribution keyword “basketball,” the content item request is deemed to meet the distribution keyword parameter, and the content item is deemed eligible for distribution based on the distribution keyword “basketball.”

When the first set of distribution parameters includes additional distribution parameters, those additional distribution parameters may also be required to be met in order for a bid associated with the first set of distribution parameters to be deemed eligible and, for example, submitted to a content item auction that will facilitate selection of the content item provided in response to the content item request. However, for brevity, it is assumed throughout the examples provided that the distribution keyword parameter “basketball” is the only distribution parameter included in the first set of distribution parameters.

A restrictive distribution parameter is received from the content item provider (204). In some implementations, the restrictive distribution parameter is an additional distribution parameter that, in combination with the first set of distribution parameters, defines a second set of distribution parameters more restrictive than the first set of distribution parameters. Continuing with the example above, assume that the content item provider is interested in distributing one or more content items to users that submitted a request for content (e.g., associated with a search query) matching “basketball” and are determined to be from Michigan (e.g., based on an IP address of an Internet Service Provider from which the content item request was received). In this example, the content item provider can submit a restrictive distribution parameter, such as a geographic distribution parameter having the value “MI,” in order to create a second set of distribution parameters that further limit distribution of one or more content items to requests originating from or associated with the location Michigan.

In some implementations, the restrictive distribution parameter and first set of distribution parameters either alone, or with other distribution parameters that differ from the first set of distribution parameters, can define a second set of distribution parameters that are more restrictive than the first set of distribution parameters. For example, assume that the first set of distribution parameters specifies that content items are eligible for distribution to user devices that, based on an IP address of the user's Internet Service Provider are determined to be located in the state of California. Further assume that the second set of distribution parameters includes a distribution parameter specifying that a user device associated with the content item request must be determined to be located in the city of San Francisco, Calif., for the content item to be eligible for distribution. In this example, the distribution parameter limiting distribution of content items to user devices associated with an IP address in San Francisco is a restrictive distribution parameter since it restricts the distribution of content items relative to the first set of distribution parameters.

Continuing with this example, a content item provider can further specify other distribution parameters (e.g., different from one or more of the distribution parameters in the first set of distribution parameters) that are to be included in the second set of distribution parameters. For example, assume that the content item provider creates a content item that is optimized for display on a mobile device. In this example, the content item provider may specify that the second set of distribution parameters includes a device type distribution parameter having the value “mobile,” which will limit distribution of content items to devices that have been identified as mobile devices (e.g., based on a device type indicator included in the content item request). Thus, the combination of the geographic distribution parameter “San Francisco, Calif.” and the device type distribution parameter “mobile” can define the second set of distribution parameters that are used to distribute a mobile optimized content item.

Like the first set of distribution parameters, the second set of distribution parameters controls distribution of one or more content items. The content items distributed based on the second set of distribution parameters can be the same content items that are distributed based on the first set of distribution parameters or different content items.

A first bid for the first set of distribution parameters is identified (206). The first bid can be identified, for example, from a data store in which the first bid is associated with (e.g., stored with a reference to or indexed according to) the first set of distribution parameters. In some implementations, the first bid is a maximum value that a content item provider is willing to be charged for distribution of a content item based on the first set of distribution parameters. For example, assume that a received content item request includes request data that meet the first set of distribution parameters. In this example, a content item that is distributed using the first set of distribution parameters will be eligible to be provided in response to the received content item request, and the first bid will be submitted, for example, to a content item auction that will facilitate selection of the content item to be provided in response to the content item request. In other words, the first bid can be the bid that is currently associated with the first set of distribution parameters.

In some implementations, the first bid is a value that is based on a historical bid value that has been associated with the first set of distribution parameters. For example, the first bid can be a historical average (or another measure of central tendency) bid value, a historical low bid value, or a historical maximum bid value that has been associated with the first set of distribution parameters. For example, if a content item provider varies their bid value over a period of time, the various bid values over that period can be used to determine the identified first bid. The period over which the historical bid values are used for determining the first bid can be limited to a specified period (e.g., 1 hour, 3 months, 6 months, a year, or longer), or can include all historical bid values associated with the first set of distribution parameters.

A peak bid for the second set of distribution parameters is determined (208). In some implementations, the peak bid is determined based at least in part on the first bid. For example, the value of the peak bid can be determined to be a multiple of the first bid, a percentage of the first bid, or another value determined based on the first bid (e.g., an exponential of the first bid or an amount added to the first bid). The peak bid is a highest bid that will be accepted from the content item provider for the second set of distribution values.

In some implementations, the peak bid is determined by identifying a bid adjustment value and computing the peak bid based on the bid adjustment value and the first bid. For example, the peak bid can be a product, sum, or logarithmic function of the bid adjustment value and the first bid. The bid adjustment value can be selected, for example, by an administrator of the distribution management apparatus or content distribution system, and identified from a data store in which the bid adjustment value is stored.

A second bid for the second set of distribution parameters is received from the content item provider (210). In some implementations, the second bid specifies a maximum value that the content item provider is willing to be charged (or willing pay) for distribution of content items based on the second set of distribution parameters. For example, assume that a content item request meeting the second set of distribution parameters is received, and that the second bid is identified as the winning bid. In this example, the content item provider will pay an amount that is equal to or less than the second bid.

A content item provider may specify a different bid for each set of distribution parameters. For example, the amount that a content item provider is willing to pay to distribute to a content item user that submits the query “basketball” (e.g., independent of the user's location) may differ from the amount that the content item provider is willing to pay for distribution of the same advertisement to a user that is determined to be in Michigan and submitted the search query “basketball.” Thus, the bid associated with the second set of distribution parameters may be higher than the bid associated with the first set of distribution parameters.

A determination is made whether the received second bid exceeds the peak bid (212). The determination can be made, for example, by comparing the value of the received second bid to the peak bid to determine which of the second bid or the peak bid has a higher value.

When it is determined that the received bid exceeds the peak bid, the content item provider is notified that the received bid exceeds the peak bid (214). For example, assume that a content item provider increases their existing bid (e.g., a previously accepted bid) for the second set of distribution parameters, and that the increased bid that is received from the content item provider exceeds the peak bid. In this example, the content item provider can be informed that the increased bid exceeds the peak bid.

The information provided to the content item provider can include information specifying the peak bid, and inviting the content item provider to submit a new bid that has a value not to exceed the peak bid. For example, a user interface, such as an advertisement campaign management interface, through which the content item provider inputs bids for sets of distribution parameters can provide a message to the advertiser informing the content item provider of the value of the peak bid. In another example, a distribution management apparatus, or content distribution system can send an e-mail, text message, or another electronic message to the content item provider alerting the content item provider that the received bid exceeds the peak bid for the second set of distribution parameters.

When the determination is made that a received bid exceeds the peak bid, a previously accepted bid for the second set of distribution parameters can remain associated with the second set of distribution parameters until a received bid that does not exceed the peak bid is accepted.

In some implementations, the information provided to the content item provider includes information about how the content item provider can increase their peak bid for the second set of distribution parameters. For example, the information provided can inform the content item provider that increasing their bid, or their average bid over a specified period, for the first set of distribution parameters will result in an increased peak bid, thereby enabling the content item provider to associate a higher bid with the second set of distribution parameters.

In some implementations, the information provided to the content item provider can include information specifying an estimated return on investment that may be achieved using different sets of distribution parameters at various bid values. The estimated return on investment can be determined, for example, based on historical information about auction results, click through rates, and/or conversion rates for content items that were distributed based on the sets of distribution parameters. This information coupled with the information informing the content item provider how they can increase their peak bid can help an advertiser determine what bid levels will achieve their content item distribution goals.

When it is determined that the received bid does not exceed the peak bid, the received second bid is associated with the second set of distribution parameters (216). The received second bid can be associated with the second set of distribution parameters can be associated with the second set of distribution parameters, for example, by storing the second bid with a reference to the second set of distribution parameters.

Content items are distributed based on the first set of distribution parameters and the second set of distribution parameters (218). For example, assume that a content item request including request data that meet the first set of distribution parameters, but do not meet the second set of distribution parameters, a bid associated with the first set of distribution parameters is provided for use in a content item auction that is used to select a content item to be provided in response to a content item request.

In this example, a winning bid can be selected, based at least in part on the bid associated with the first set of distribution parameters, and any other bids that were submitted to the auction, and the auction winner will be charged some amount that does not exceed the auction winner's bid. For example, assume that the bid associated with the first set of distribution parameters is identified by the auction as the winning bid. In this example, the price charged to the content item provider will be an amount less than or equal to the bid associated with the first set of distribution parameters. The price can be, for example, the amount of the bid associated with the first set of distribution parameters, the amount of the next highest bid that was submitted to the auction, some incremental amount more than the next highest bid, or another amount that does not exceed the bid associated with the first set of distribution parameters. Thus, the bid associated with the first set of distribution parameters limits the amount that the content item provider will be required to pay for distribution of the content item based on the first set of distribution parameters.

In another example, assume that a content item request is received including request data that meet the second set of distribution parameters. In this example, the second bid will be provided for use in the content item auction. In some implementations, the second bid will be provided even if the request data also meet the first set of distribution parameters since the second set of distribution parameters includes the restrictive distribution parameters, and is therefore, more specific than the second set of distribution parameters.

The auction will select a winning bid based on the second bid and any other bids that were submitted to the auction, and the content item provider will be charged a price in a manner similar to that described above.

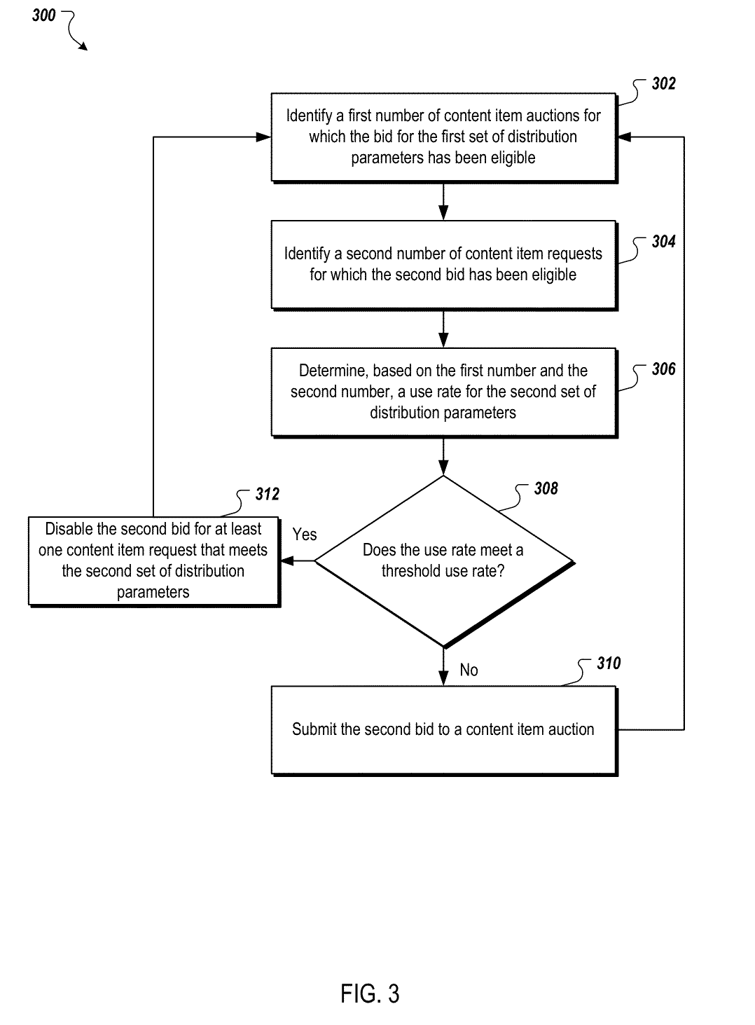

FIG. 3 is a flow chart of an example process 300 for temporally managing utilization of distribution parameters. As discussed above, utilization of distribution parameters can be temporally managed by managing how often (e.g., a rate at which) a content item provider can utilize a set of distribution parameters. The process 300 can be performed by one or more data processing apparatus, such as the distribution management apparatus 120 and/or the content distribution system 110 of FIG. 1. Operations of the process 300 can be implemented by execution of instructions stored on a non-transitory computer readable medium and that cause one or more data processing apparatus to perform operations of the process 300.

A first number of content item auctions for which the bid for the first set of distribution parameters has been eligible are identified (302). In some implementations, the first number of content item auctions can be identified in a data store that stores the first number of content item auctions. For example, the distribution management apparatus and/or the content distribution system can track the number of auctions to which a bid associated with the first set of distribution parameters was submitted. The first number of content item auctions can be limited to a specified historical period (e.g., 1 hour, 3 months, 6 months, or 12 months) or can include all available historical data.

A second number of content item auctions for which the second bid has been eligible are identified (304). In some implementations, the second number of content item auctions can be identified in a data store that stores the second number of content item auctions. For example, the distribution management apparatus and/or the content distribution system can track the number of auctions to which the second bid was submitted. The second number of content item auctions can be limited to a specified historical period (e.g., 1 hour, 3 months, 6 months, or 12 months) or can include all available historical data.

A use rate for the second set of distribution parameters is determined based on the first number and the second number (306). The use rate for the second set of distribution parameters can be determined, for example, based on a ratio of the second number of content item auctions relative to the first number of content item auctions (e.g., use rate=(second number of content item auctions)/(first number of content item auctions)). In some implementations, the use rate for the second set of distribution parameters can be determined based on a ratio of the second number of content item auctions relative to a sum of the first number of content item auctions and the second number of content item auctions (e.g., use rate=(second number of content item auctions)/(first number of content item auctions+second number of content item auctions)).

A determination is made whether the use rate for the second set of distribution parameters meets a threshold use rate (308). In some implementations, the use rate meets the threshold rate when the use rate equals or exceeds the threshold use rate. The threshold use rate can be specified, for example, in the distribution management apparatus and/or content distribution system. In some implementations, the threshold use rate limits the use of the second set of distribution parameters relative to the total use of the first set of distribution parameters.

When the use rate for the second set of distribution parameters is determined to not meet the threshold use rate, the second bid is submitted to a content item for which the second bid is determined to be eligible (310). For example, when the use rate is less than the threshold use rate, the second set of distribution parameters are eligible to control distribution of content items. Therefore, the second bid is eligible to be submitted to a content item auction when a content item request that meets the second set of distribution parameters is received.

When the use rate for the second set of distribution parameters is determined to meet the threshold use rate, the second bid is disabled for at least one content item request that meets the second set of distribution parameters (312). For example, when the use rate is greater than the threshold use rate, the use of the second set of distribution parameters exceeds the limits on the use of the second distribution parameters that are enforced by the threshold use rate. Therefore, the second set of distribution parameters should be made ineligible to control distribution of content items until the use rate no longer meets the threshold use rate. In some implementations, the second set of distribution parameters are made ineligible by disabling the second bid. For purposes of this document, disabling the second bid can include any actions or inactions that result in the second bid not being selected as the winning bid for an action.

The process 300 can iteratively determine/monitor the use rate and manage submission of the second bid to content item auctions, thereby temporally managing utilization of the second set of distribution parameters based on the temporal use of the first set of distribution parameters.

The foregoing described managing the utilization of distribution parameters either temporally or based on a peak bid will be accepted. The operations and techniques described above can be used independently or together. For example, the peak bid may be temporally utilized such that the peak bid management may be invoked when the use rate of a second bid that exceeds the peak bid meets a threshold.

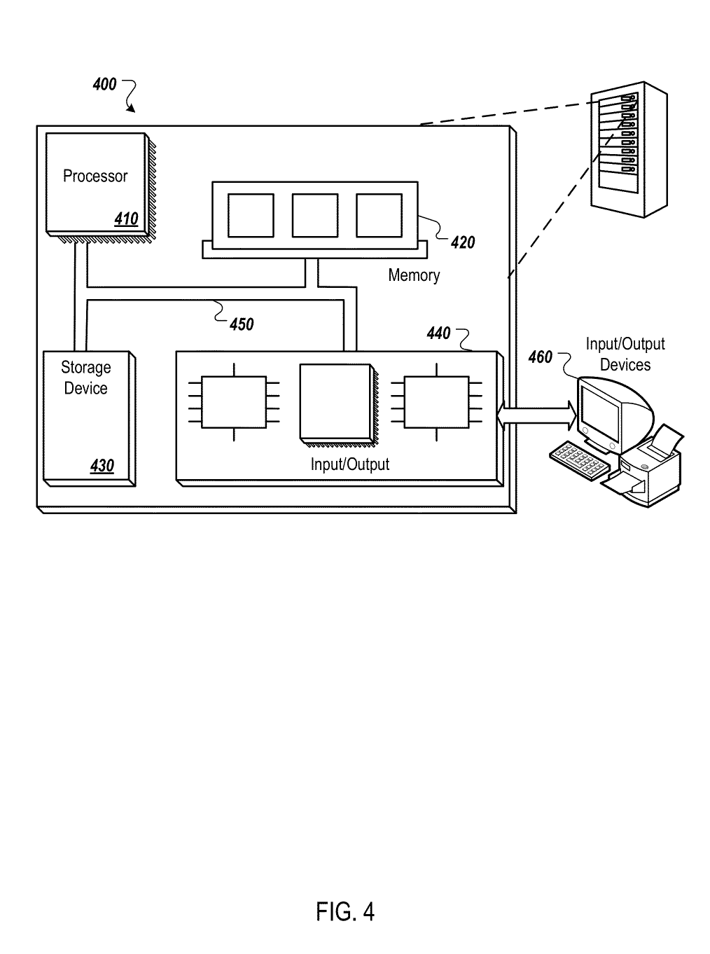

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
identifying, for a content item provider, a first set of distribution parameters for distributing a set of content items;
receiving, from the content item provider, a restrictive distribution parameter that is included in a second different set of distribution parameters, wherein the restrictive distribution parameter is different from any distribution parameters in the first set of distribution parameters;
identifying, by one or more data processing apparatus, a first bid for the first set of distribution parameters, the first bid being based on a value that the content item provider has specified for distribution of a content item in response to a content item request that meets the first set of distribution parameters, but does not meet the second set of distribution parameters;
determining, by one or more data processing apparatus, an acceptable peak bid for the second set of distribution parameters, the acceptable peak bid being greater than and determined based at least in part on the first bid;
receiving, from the content item provider, a second bid for the second set of distribution parameters, the second bid being a value that the content item provider has specified for distribution of a content item in response to a content item request that meets the second set of distribution parameters;
determining that the second bid does not exceed the peak bid; and
associating the second bid with the second set of distribution parameters.

2. The method of claim 1, comprising:
receiving, from the content item provider, a third bid that differs from the second bid;
determining that the third bid exceeds the peak bid;
providing information to the content item provider indicating that the third bid exceeds the peak bid.

3. The method of claim 1, comprising:
receiving a first content item request including request data that meet the first set of distribution parameters, but do not meet the second set of distribution parameters; and
providing, in response to receiving the first content item request, a bid associated with the first set of distribution parameters for use in a content item auction.

4. The method of claim 3, comprising:
receiving a second content item request including request data that meets the second set of distribution parameters; and
providing, in response to the second content item request the second bid for use in a content item auction.

5. The method of claim 1, wherein determining the peak bid comprises:
identifying a bid adjustment value for the second set of distribution parameters; and
computing the peak bid based on the bid adjustment value and the first bid.

6. The method of claim 1, comprising:
determining a first number of content item auctions for which a bid for the first set of distribution parameters has been eligible;
determining a second number of content item request auctions for which the second bid has been eligible; and
determining, based on the first number of content item request auctions and the second number of content item request auctions, a use rate for the second set of distribution parameters.

7. The method of claim 6, comprising:
determining that the use rate for the second set of distribution parameters meet a threshold use rate for the second set of distribution parameters; and
disabling the second bid for at least one content item request.

8. A non-transitory computer storage medium encoded with a computer program, the program comprising instructions that when executed by one or more data processing apparatus cause the one or more data processing apparatus to perform operations comprising:
identifying, for a content item provider, a first set of distribution parameters for distributing a set of content items;
receiving, from the content item provider, a restrictive distribution parameter that is included in a second different set of distribution parameters, wherein the restrictive distribution parameter is different from any distribution parameters in the first set of distribution parameters;
identifying a first bid for the first set of distribution parameters, the first bid being based on a value that the content item provider has specified for distribution of a content item in response to a content item request that meets the first set of distribution parameters, but does not meet the second set of distribution parameters;
determining an acceptable peak bid for the second set of distribution parameters, the acceptable peak bid being greater than and determined based at least in part on the first bid;
receiving, from the content item provider, a second bid for the second set of distribution parameters, the second bid being a value that the content item provider has specified for distribution of a content item in response to a content item request that meets the second set of distribution parameters;
determining that the second bid does not exceed the peak bid; and
associating the second bid with the second set of distribution parameters.

9. The computer storage medium of claim 8, wherein the instructions cause the one or more data processing apparatus to perform operations comprising:
receiving, from the content item provider, a third bid that differs from the second bid;
determining that the third bid exceeds the peak bid;
providing information to the content item provider indicating that the third bid exceeds the peak bid.

10. The computer storage medium of claim 8, wherein the instructions cause the one or more data processing apparatus to perform operations comprising:
receiving a first content item request including request data that meet the first set of distribution parameters, but do not meet the second set of distribution parameters; and
providing, in response to receiving the first content item request, a bid associated with the first set of distribution parameters for use in a content item auction.

11. The computer storage medium of claim 10, wherein the instructions cause the one or more data processing apparatus to perform operations comprising:
receiving a second content item request including request data that meets the second set of distribution parameters; and
providing, in response to the second content item request the second bid for use in a content item auction.

12. The computer storage medium of claim 8, wherein determining the peak bid comprises:
identifying a bid adjustment value for the second set of distribution parameters; and
computing the peak bid based on the bid adjustment value and the first bid.

13. The computer storage medium of claim 8, wherein the instructions cause the one or more data processing apparatus to perform operations comprising:
determining a first number of content item auctions for which a bid for the first set of distribution parameters has been eligible;
determining a second number of content item request auctions for which the second bid has been eligible;
determining, based on the first number of content item request auctions and the second number of content item request auctions, a use rate for the second set of distribution parameters;
determining that the use rate for the second set of distribution parameters meet a threshold use rate for the second set of distribution parameters; and
disabling the second bid for at least one content item request.

14. A system comprising:
a data storage device storing a first set of distribution parameters for distributing a set of content items for a content item provider; and
one or more data processing apparatus that interact with the data storage device and execute instructions that cause the one or more data processing apparatus to perform operations comprising:
receiving, from the content item provider, a restrictive distribution parameter that is included in a second different set of distribution parameters, wherein the restrictive distribution parameter is different from any distribution parameters in the first set of distribution parameters;
identifying a first bid for the first set of distribution parameters, the first bid being based on a value that the content item provider has specified for distribution of a content item in response to a content item request that meets the first set of distribution parameters, but does not meet the second set of distribution parameters;
determining an acceptable peak bid for the second set of distribution parameters, the acceptable peak bid being greater than and determined based at least in part on the first bid;
receiving, from the content item provider, a second bid for the second set of distribution parameters, the second bid being a value that the content item provider has specified for distribution of a content item in response to a content item request that meets the second set of distribution parameters;
determining that the second bid does not exceed the peak bid; and
associating the second bid with the second set of distribution parameters.

15. The system of claim 14, wherein the instructions cause the one or more data processing apparatus to perform operations comprising:
receiving, from the content item provider, a third bid that differs from the second bid;
determining that the third bid exceeds the peak bid;
providing information to the content item provider indicating that the third bid exceeds the peak bid.

16. The system of claim 14, wherein the instructions cause the one or more data processing apparatus to perform operations comprising:
receiving a first content item request including request data that meet the first set of distribution parameters, but do not meet the second set of distribution parameters; and
providing, in response to receiving the first content item request, a bid associated with the first set of distribution parameters for use in a content item auction.

17. The system of claim 16, wherein the instructions cause the one or more data processing apparatus to perform operations comprising:
receiving a second content item request including request data that meets the second set of distribution parameters; and
providing, in response to the second content item request the second bid for use in a content item auction.

18. The system of claim 14, wherein determining the peak bid comprises:
identifying a bid adjustment value for the second set of distribution parameters; and
computing the peak bid based on the bid adjustment value and the first bid.

19. The system of claim 14, wherein the instructions cause the one or more data processing apparatus to perform operations comprising:
determining a first number of content item auctions for which a bid for the first set of distribution parameters has been eligible;
determining a second number of content item request auctions for which the second bid has been eligible;
determining, based on the first number of content item request auctions and the second number of content item request auctions, a use rate for the second set of distribution parameters.

20. The system of claim 19, wherein the instructions cause the one or more data processing apparatus to perform operations comprising:
determining that the use rate for the second set of distribution parameters meet a threshold use rate for the second set of distribution parameters; and
disabling the second bid for at least one content item request.
